(19) United States
(12) Patent Application Publication
(10) Pub. No.: US 2026/0243690 A1
(43) Pub. Date: Aug. 20, 2026

(54) Sample Packaging and Storage Devices and Methods

(71) Applicant: The Government of the United States of America, as represented by the Secretary of Homeland Security, Washington, DC (US)

(72) Inventors: Emily Blackford, Howell, NJ (US); John Brady, Medford, NJ (US); Alicia Broderick, Sewell, NJ (US); Jeffrey Barber, Vineland, NJ (US)

(73) Assignee: The Government of the United States of America, as represented by the Secretary of Homeland Security, Washington, DC (US)

(21) Appl. No.: 18/990,727

(22) Filed: Dec. 20, 2024

Related U.S. Application Data
(60) Provisional application No. 63/623,398, filed on Jan. 22, 2024.

(51) Int. Cl. G01N 21/78; B65B 11/52; B65D 75/36; G01N 21/77

(52) U.S. Cl. CPC G01N 21/78; B65B 11/52; B65D 75/367; G01N 2021/7759

(57) ABSTRACT

Examples are directed toward a system and method relating to sample packaging and storage. For example, a device to store a material includes packaging comprising a scooped dish shape. A material is stored in the packaging, the material being an explosive or threat.

### CROSS-REFERENCE TO RELATED APPLICATIONS

This application is a nonprovisional application that claims the benefit of priority from U.S. Provisional Application No. 63/623,398 entitled “Sample Packaging and Storage Devices and Methods,” filed on Jan. 22, 2024, the contents of which are incorporated herein by reference in their entirety.

### STATEMENT OF GOVERNMENT INTEREST

The claimed subject matter was made by one or more employees of the United States Department of Homeland Security in the performance of official duties. The Government has certain rights in the invention.

### FIELD

The present subject matter relates generally to the field of packaging and storage, and more specifically to the field of packaging and storage of explosive test samples.

### BACKGROUND

Members of transportation security and other related fields may benefit from a positive explosives identification aid to improve training. Currently, there are no safe and compact teaching aids in the field.

### SUMMARY

Example embodiments of test detection include a device to store a material, including packaging comprising a scooped dish shape. A material is stored in the packaging, the material being an explosive or threat.

In another example embodiment, a system to test detection systems includes a plurality of devices. A given device includes packaging including a scooped dish shape, and a material stored in the packaging. The plurality of devices include a plurality of materials, respectively, representing at least those types of explosives or threats capable of being detected by the detection systems.

In yet another example embodiment, a method to test detection systems includes dissolving an explosive compound or threat in a solvent to form a solution, disposing the solution in a packaging having a scooped dish shape, evaporating the solvent from the solution, and sealing the packaging.

Other features and aspects will become apparent from the following detailed description, which taken in conjunction with the accompanying drawings illustrate, by way of example, the features in accordance with embodiments of the claimed subject matter. This summary is not intended to identify key or essential features of the claimed subject matter, nor is it intended to limit the scope of the claimed subject matter, which is defined solely by the claims attached hereto.

### BRIEF DESCRIPTION OF THE DRAWINGS

One or more example embodiments of the subject matter are described in detail with reference to the following drawings. These drawings are provided to facilitate understanding of the present subject matter and should not be read as limiting the breadth, scope, or applicability thereof. For purposes of clarity and ease of illustration, these drawings are not necessarily made to scale.

FIG. 1 illustrates a colorimetric testing kit according to an example embodiment.

FIG. 2 illustrates example blister packs.

FIG. 3 illustrates example Fourier Transform Infrared spectroscopy (FTIR).

FIG. 4 illustrates an example gas chromatograph with a beta emission detector.

FIG. 5 illustrates an example procedure for colorimetric testing.

FIG. 6 illustrates samples of the deposited explosive in a metal tray to be placed in oven according to an example embodiment.

FIG. 7 illustrates data and results of different solvents on different plastic forms according to an example embodiment.

FIG. 8 illustrates samples of different solvents on a Medi-Aid blister pack according to an example embodiment.

FIG. 9 illustrates samples of different solvents on a Pill Thing blister pack according to an example embodiment.

FIG. 10 illustrates FTIR spectrums for an EZY Dose sample.

FIG. 11 illustrates FTIR spectrums for a Pill Thing sample.

FIG. 12 illustrates FTIR spectrums for a Medi-Aid sample.

FIG. 13 illustrates FTIR spectrums for a contact lens case sample.

FIG. 14 illustrates a scooped dish form with thumb for size reference according to an example embodiment.

FIG. 15 illustrates a scooped dish form according to an example embodiment.

FIG. 16 illustrates a CAD design for a scooped dish form according to an example embodiment.

FIG. 17 illustrates a CAD design for a scooped dish form according to an example embodiment.

FIG. 18 illustrates a CAD design for a scooped dish form with a thumbprint for reference according to an example embodiment.

FIG. 19 illustrates a chromatogram to check interference between explosives, a prototype, and solvents according to an example embodiment.

FIG. 20 illustrates a diagram of an example method according to an example embodiment.

FIG. 21 illustrates a chromatogram to check extraction methods according to an example embodiment.

FIG. 22 illustrates a microscope optical scan of an example form according to an example embodiment.

FIG. 23 illustrates a form according to an example embodiment.

FIG. 24 illustrates a form according to an example embodiment.

FIG. 25 illustrates a microscope optical scan of an example form according to an example embodiment.

FIG. 26 illustrates a chromatogram comparing recovery of the explosive between controls and samples according to an example embodiment.

FIG. 27 illustrates a cross-section view of a form containing a threat according to an example embodiment.

FIG. 28 illustrates forms for containing threats according to an example embodiment.

FIG. 29 illustrates a flowchart of a method to refine a prototype form for storing explosives according to an embodiment.

These drawings are not intended to be exhaustive or to limit the subject matter to the precise form(s) disclosed. It should be understood that the present subject matter can be practiced with modification and alteration, and that the subject matter is limited only by the claims and the equivalents thereof.

### DETAILED DESCRIPTION

Explosive test samples can be stored in a multitude of ways which include solutions. Due to the sensitive nature of explosives, care must be taken that the package is sufficiently durable to ensure viability of the sample. One potential method to package and store these materials would be to utilize blister packaging consisting of a threat receptacle portion and a film cover. The receptacle needs to consist of a chemically compatible material which is covered with second packaging layer which is then sealed. In an embodiment, a method includes depositing a sample solution/mixture in a packaging, and allowing the solvent to evaporate to leave behind a trace amount of the sample in the packaging. The sample that is dissolved or suspended in the solvent can based on explosives or other threats. Embodiments can be used to package various types of explosives, such as Research Department explosive (RDX), also referred to as hexogen. The sample also can be based on other materials such as illicit drugs (e.g., narcotics), a gas forming reagents (GFR), and so on

The packaging is impermeable to the sample material and solvents including but not limited to methanol, acetonitrile, ethanol, acetonitrile, toluene, tetrahydrofuran. The packaging, such as a blister pack, can be formed in a manner that allows for effective sampling of the threat contained in the packaging or testing the threat directly in the packaging and will be based on the desired concept of operations per the customer. The packaging can be a chemically compatible thermoformed or cold-formed blister pack, to store the material at quantities ranging from picogram (pg) to milligram (mg), depending on the customer application. Embodiments may have one or more different samples or threats in separate compartments of the packaging. The packaging may be made of a plastic such as but not limited to PVC, PVC laminates (e.g., PVC-coated with PTFE), aluminum, aluminum laminates, polyethylene terephthalate, polyethylene terephthalate glycol, etc. or another material that is chemically compatible with the samples or solvents used to prepare the samples.

In an embodiment, the device may consist of a kit including several packages. A given package can be formed, in one embodiment, with a concave scooped-bottom dish. The concave scooped-bottom dish allows for efficient swabbing, e.g., of dried residue from the package in embodiments containing a dry material. In another embodiment, the packaging has a non-linear shape of maximum length L of 47.8 mm, a maximum width (W) of 30.5 mm, and a maximum height (H) of 10 mm.

Embodiments of the packaging are provided that are compatible with other techniques for sample retrieval. For example, the packaging may include a receptacle portion that is designed in a manner (e.g., shape, material type and thickness) so that the selected packaging layer (e.g., an injected mold plastic) is capable of limited elastic deflection, allowing for inverting the packaging to deposit the sample onto the testing surface/swab. The packaging may include a chemically compatible and/or transparent plastic, allowing for the testing equipment (such as a colorimetric testing kit) to test the sample directly in the package, without needing to remove the sample from the package. Further in one embodiment, an absorbent layer may be included in the threat receptacle area to facilitate retention of liquid samples. Further, color may be added to the packaging to facilitate a color change/visualization of a material (i.e., use of white plastic)

In order to reduce the overall cost to the customer, the cost and size of the packaging should be kept to a minimum. Additionally, the disposability of the packaging necessitates conformity with ecological standards. Nevertheless, embodiments allow for tailoring the size and shape of the packaging to accommodate specific different types of samples, so that the remaining traces of samples in the packaging are tailored for swabbing an amount suitable for testing purposes using the particular testing equipment of a given vendor for that detecting that type of material. Different vendors use different swabs and testing procedures, and the packaging is tailored to accommodate the different types of vendors and their testing equipment and procedures.

The sample can be prepared by using a portion of the packaging to hold a solution of the sample and solvent to allow the solvent to evaporate. The material may or may not be dried when stored in the blister pack depending on the threat and the customer application. In some embodiments, the packaging is sealed with some or all solvent remaining in the packaging with the sample to facilitate transport of the packaging or to meet a customer need. Once the threat receptacle area is filled and dried (if required), and second packaging layer is used to cover the threat which is used to seal the blister pack. This seal is also impermeable to the sample (e.g., liquid threats) and selected solvents. Once sealed, the packaged material would allow for the explosive samples to be used once and then then discarded. Further, by packaging the material it would allow for samples of explosives or other materials to be transported safely at an acceptable mass quantity and would facilitate shelf-life/stability (i.e., long-term storage) of the material.

The secondary seal layer/cover can be sealed in a manner so that the seal type/method is compatible with any solid or liquid (e.g., solvent) that may be present. Sealing may performed via the application of heat sealing, cold sealing, rf sealing, ultrasonic sealing, or induction sealing, with or without the use bonding agents or lacquers. In addition, an inert gas such as nitrogen may be added to remove oxygen and increase shelf-life. In another, embodiment, a third perforated layer between the threat receptacle and the sealing layer may be added. This additional layer would allow for vapor to permeate out in a controlled manner facilitating use in vapor scenarios such as a vapor detection system or canine olfaction detection.

Embodiments include kits containing a plurality of packaging units containing respective different types of materials, or combination of materials inside a given packaging unit. Methods for using the packaging containing threat materials include training or other scenarios that involve using the material from the packaging as a positive control, because the material is an actual threat material. The user selects the corresponding packaging, which can be a blister pack containing the threat material. The user opens the packaging and uses the material or collects the material from the packaging in a manner consistent with the testing methodology. For example, the user can use the material as a training aid (e.g., for training canines to detect the odor of threat or contraband materials). The user also can collect the material, e.g., by swiping the interior of the packaging using a swab, to collect the deposited material onto the swab. Retrieval of the material may include inverting the packaging, swabbing into the package, or testing directly in the package. The user proceeds with testing the collected sample in a manner that is consistent with the analysis methodology. Some potential examples and embodiments are shown below.

The packaging can be deployed in the field for an agent to swab the sample from the packaging and perform field testing to confirm that the test equipment is working properly to detect the sample, whether it is a threat or other material. The user can insert the swab in an analysis machine to validate or verify that the analysis machine is properly and correctly functioning to provide valid threat responses. Such techniques also can be used to test and verify that the user's approach and methodology for collecting and testing the sample are correct in a training scenario, or in the field.

An embodiment enables operators to confirm proper testing operations. This embodiment can include a sample of an explosive such as RDX deposited and dried in a blister pack style of packaging. The packaging contains enough sample at a sufficient quantity to enable colorimetric detection. The user, in the field, then obtains and opens the packaging, and swabs the contents of the blister pack for use in verifying or validating an existing alarm encountered in the field.

Aside from swabbing, other sample retrieval methods can be used to retrieve the sample threat from the packaging (whether a blister pack style of packaging or other style of packaging). In another scenario, the packaging comprises an explosive such as RDX deposited and dried in a blister pack packaging at a sufficient quantity to enable vapor/canine detection/training. Here, the user can open and expose the contents of the package to the vapor detector or canine, and to verify/validate that the detector or canine alarms on the sample in the field.

Embodiments provide packaging compatible with storing various types of samples including illicit drugs, such as cocaine. The sample is deposited and dried in the packaging at a sufficient quantity to enable trace detection. For example, the packaging is configured to store a small quantity of Fentanyl dissolved in acetonitrile ranging in concentration in the ng/uL range, which could be detected using drug assays and presumptive field drug testing.

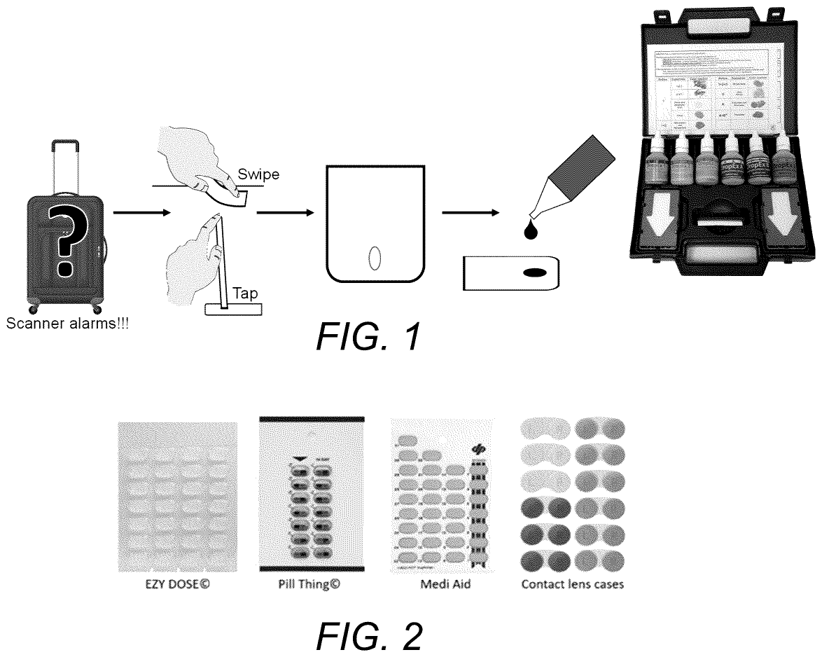

FIG. 1 illustrates a colorimetric testing kit according to an example embodiment. The current project provides the preliminary research and development for a colorimetric test kit training aid. A mixed method approach was taken for this project. Initially, different solvents and plastic samples were investigated for compatibility. An initial form was developed using 3-dimensional printing. Next, an extraction method was explored. Lastly, feasibility and shelf-life were investigated. Overall, preliminary data suggests that a positive explosive control may be feasible for field application. The final form will vary from the current design, but this prototype is a foundational training aid.

A colorimetric testing kit is a chemical identification tool. It is a color-based test where a color change is indicative of the presence of specific compounds. Different colors indicate different explosives. Typical tests are made for narcotics and explosives. Testing kits can be used to identify an explosive in the field, such as by the TSA at airports.

For the use in explosives identification, several colorimetric kits are available on the market with similar features. The Transportation Security Administration (TSA) uses these kits in airports to test scanner-alarmed substances that are suspected to be explosives. Typically, a presumed explosive sample is scooped or swiped with a test paper. Then, a chemical reagent is placed by dropper onto the paper. A specific color change would be a positive identification for a specific compound.

The primary interest of this project was to create a positive control that could be used as a training aid. This required the production of a safe and compact package that could easily be distributed during training. The training aid will be used for the detection of various contraband materials including explosives (e.g., RDX, TNT) and illicit drugs. The training aid will be able to supply a mass range from nanograms up to milligrams of the contraband material. In addition, embodiments of the training aid can allow for sampling techniques including (1) swabbing the inside of the blister pack, (2) performing the test directly inside the blister pack, (3) inverting the blister pack to drop the material onto a surface or apply pressure on the outside of the blister pack to allow direct transfer of the material onto a surface, and other techniques.

### EXPERIMENTAL METHODOLOGY

### Solvent Determination

Three different blister packs—the EZY Dose©, the Medi-Aid, and the Pill Thing© packs-were selected for solvent compatibility. Plastic contact lens cases were also tested. The following solvents were tested due to their slight solubility with selected explosive: acetone, acetonitrile, ethanol, methanol, and tetrahydrofuran. Images of the specific blister packs and contact lens cases are shown in FIG. 2, which illustrates example blister packs, which can serve as plastic forms used for original solvent testing.

A pipette was used to measure 250 μL of each solvent into the labeled packs (n=2). Each sample was left undisturbed for 2 hours to allow for evaporation. After evaporation occurred, the empty samples were analyzed for visible cracks and other damage. A microscope and profilometer were used for further analysis. Optical and laser images and surface roughness data were used to quantitate the data and determine the best solvents for use with the given plastic samples.

### Chemical Identification

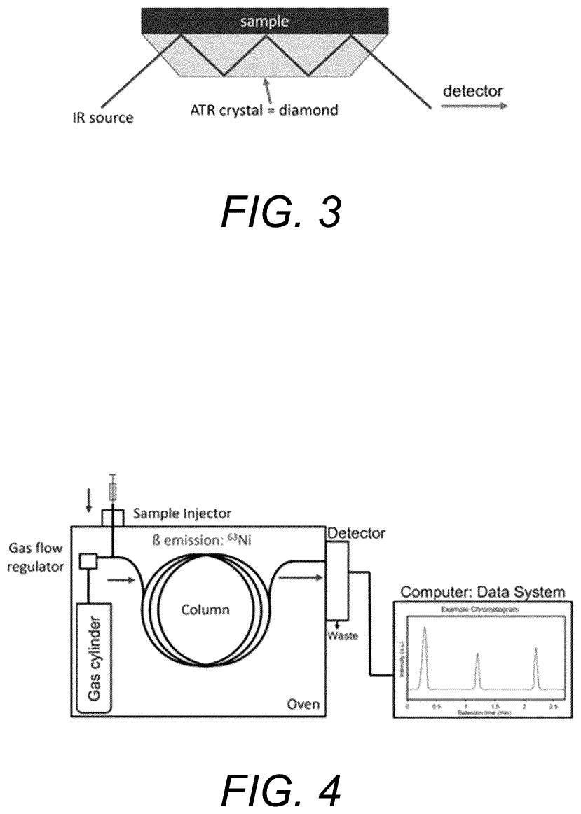

FIG. 3 illustrates example Fourier Transform Infrared spectroscopy (FTIR). The diagram shows FTIR with ATR. An IR source reflects a beam into a crystal (diamond) and hits a sample. The detector records the changes in intensity. Each plastic sample was chemically identified via Fourier Transform Infrared spectroscopy (FTIR) with Attenuated Total Reflection (ATR). FTIR provides information about the chemical identity of a sample. It uses the high refractive index of a crystal, such as diamond, to reflect a laser onto a sample. Radiation hits the molecules in the sample. The bonds in the molecule absorb the energy of the IR light and respond by vibrating/stretching. The sample may absorb some of the infrared light and cause attenuation of the reflected beam. These changes in intensity are recorded6. Different functional groups respond differently to the light beams and thus display differently on a spectrum. This makes FTIR spectroscopy a good tool to identify compounds. Each spectrum was run through the Know-It-All IR Spectral Database to compare with known samples. FIG. 1 is a diagram of what occurs during FTIR spectroscopy.

### Form Development

An ideal form for a positive explosive identification tool was developed. In order to create a safe, compact, and easily accessible product, the typical fingerprinting acquisition area of 0.5″×0.7″ was used. CAD designs were modified using ideaMaker, a 3D slicing software. The 3D printer was a Raise3D™ provided by SciTech. Samples were produced via 3-Dimensional printing using a PETG filament with a 1.75 mm diameter. The extruder was set to 255° C. and the heat bed to 60° C. No raft was used. The layer height was 0.1000 mm with an infill speed of 60.0 mm/s and infill density of 5.0%. Each 3D-printed dish was cleaned with pure methanol and a Kimwipe prior to use.

### Extraction Method

Extraction methods were investigated. A solution of explosive was prepared by suspending a quantity of the material in methanol. The concentration of explosive was varied with the experiment and step dilutions were performed as needed. From these concentrations, an aliquot was deposited onto each dish to reach the target mass loading. Two extraction methods were explored: washing and submersion. The washing method required the dish be suspended over a 50-mL plastic vial and washed 3 times with 1,000 μL of solvent. The submersion method required the dish be placed in a 50-mL vial, 3,000 μL of solvent pipetted onto it, and then vortexed for 30 seconds. Each method used 3,000 μL of an extracting solvent: an internal standard solution of 3,4-dinitrotoluene in HPLC-grade methanol. Both extraction methods were evaluated for success via gas chromatography (n=2).

### Gas Chromatography

FIG. 4 illustrates an example gas chromatograph with a beta emission detector. The Agilent Gas Chromatograph 7890 (GC) with microelectron capture detector (μECD) was used. An unknown sample is injected into the GC and vaporized via heating by an internal oven. The analyte passes through a thin coiled column in the oven. A beta emitter, 63Ni, is used to ionize the carrier gas. The beta particles collide with the carrier gas and cause ionization to occur. Slow-moving electrons are produced and create a steady, measurable current. The electron-absorbing sample captures electrons and reduces the current detected by the anode. The rate of electron capture is recorded. This rate is proportional to the concentration of the sample.7 FIG. 2 is a general diagram of a gas chromatograph with a beta emitter.

The GC method used for the quantification of the threat uses a pulsed splitless liner. The run time is 7 minutes. The front inlet is splitless and set at 160° C. with a pressure of 4 psi. The flow rate is between 30.00-45.00 mL/min with a septum purge flow of 10.0 mL/min. Helium gas is the carrier gas and P5 is the ECD makeup gas.

The method was loaded into the GC. Initial testing was conducted to determine if interference occurred between the PETG 3D material, methanol, acetonitrile, and selected explosive. A sample of the explosive in solution was placed in a vial and run on GC. Then, two 50-mL vials were filled with 3 mL of either methanol or acetonitrile. A PETG prototype dish was submersed in each vial. Each sample was run on a gas chromatograph to check for interference peaks.

After initial testing, more tests with the explosive were carried out. The following sequence is typical for a GC run: a prime and two calibration blanks, then a seven-point calibration curve with 3 injections per calibration point. After the calibration curve, high and low continuous calibration verifications (CCVs) and external calibration verifications (ECVs) were run. Then unknown samples were run, followed by CCVs and calibration blanks.

Seven-point calibration curves were used to quantify data. HPLC grade acetonitrile was the chosen solvent. The extracting solvent was 3,4-dinitrotoluene in HPLC-grade acetonitrile.

### Verification of Feasibility

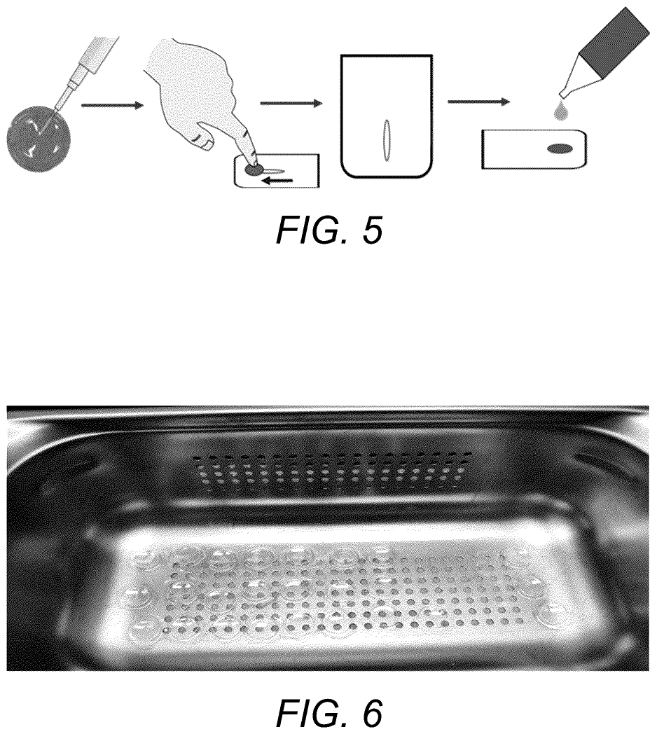

FIG. 5 illustrates an example procedure for colorimetric testing. After preliminary data was collected, the prototype and concept were tested for feasibility. A DropEx Plus colorimetric kit (Mistral Security Inc.) was used. A sample of the selected explosive in acetonitrile was prepared. An aliquot of the explosive solution was deposited onto cut PETG blister packs (n=22). Samples of polyethylene terephthalate (PET) from the bottom of an egg carton (Bowl and Basket brand, 30 count) were also used for additional depositions (n=10). After the solvent was evaporated, each sample was swabbed with a test strip. Three to four drops of the appropriate chemical reagent bottles were used in combination with the swabs to verify functionality of the colorimetric kit/training aid design.

If the explosive was detectable, the strip would indicate a particular color. FIG. 3 shows the process for each sample. The positive control was a direct deposit of explosive solution onto the swab. Negative controls were colorimetric reagent deposits on a blank test strip and a test strip swabbed on a blank blister pack.

### Accelerated Shelf-Life Study

FIG. 6 illustrates samples of the deposited explosive in a metal tray to be placed in oven according to an example embodiment. Samples of the deposited explosive in a metal tray to be placed in oven (n=22). Negative controls right. A shortened and accelerated 48-hour shelf-life study was conducted to investigate the possibility of transporting and distributing these containers to training locations. Samples of polyethylene terephthalate (PET) from the bottom of an egg carton (Bowl and Basket brand, 30 count) were used for this study.

48-hour, Extreme Conditions: unsealed, 60±5° C., Investigate possibility of transporting containers to training locations, Samples of PET, Depositions of explosive in acetonitrile.

Depositions of the selected explosive in acetonitrile were made and the solvent was given time to evaporate. Then, samples were placed in a metal tray and placed in the oven (n=22). Image 2 shows the samples placed in the tray.

The positive controls of the selected explosive and the negative controls (i.e., blank plastic sample in the oven) were included in the study to verify performance. The oven used was a Thermo PR305225M and was set to 60±5° C. The samples were left for 48 hours. Once removed, the samples were cooled, extracted, and analyzed on the GC. The extraction solvent was 3,4-dinitrotoluene in HPLC-grade acetonitrile. A follow-up study was carried out where a quantity of the selected explosive was deposited and left under ambient laboratory for 72 hours and then extracted and analyzed via GC (n=10).

### RESULTS AND DISCUSSION

### Solvent Determination

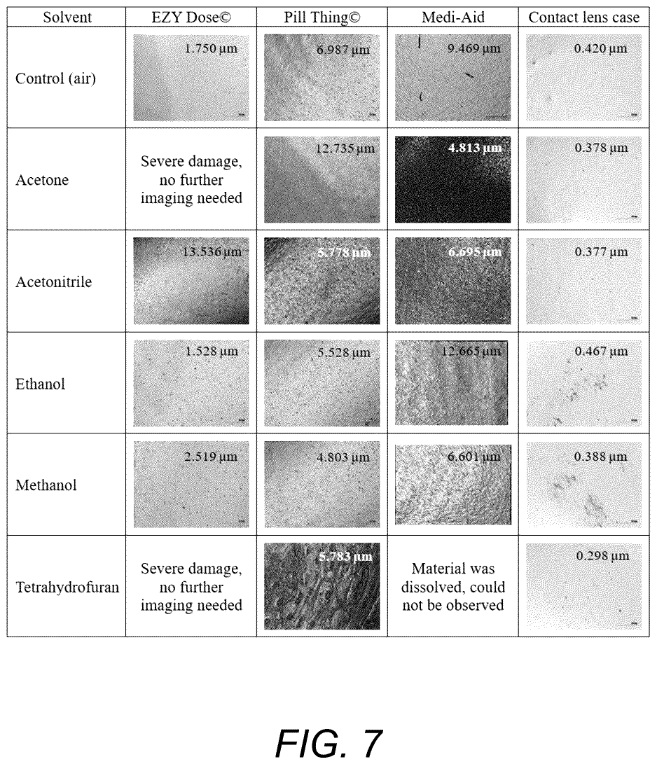

FIG. 7 illustrates data and results of different solvents on different plastic forms according to an example embodiment. Microscope and profilometer data for 5 different solvents were used on different plastic forms. The selected explosive is slightly soluble in five common solvents: acetone, acetonitrile, ethanol, methanol and tetrahydrofuran. Acetone and tetrahydrofuran caused significant damage to the blister packs. The materials were observed under a microscope and profilometer. Table 1 shows the microscope images for each sample with the five different solvents and the control. Also included are the average surface roughness measurements for each sample. Images 3 and 4 show the solvent interactions with the Medi-Aid and Pill Thing© blister packs.

From these images and surface roughness data from the optical profilometer, it was concluded that each of the samples were not significantly affected by exposure to methanol and ethanol (p>0.05). Each surface remained relatively smooth when quantified with the profilometer. Acetonitrile slightly affected each sample, with changes in surface roughness observed with the EZY Dose© blister pack (p<0.01). Lower volumes of solvent did not cause significant damage which was explored during interference and feasibility testing.

The Medi-Aid blister pack had significant damage when exposed to all of the solvents. Additionally, the contact-lens-case form was eliminated. Ridges observed on the inside of the material would pose issues with swabbing. In the future, a plastic similar to this case could still be used but was not tested further during this project. The damage and potential issues with these two plastics resulted in their elimination from further form development. Based on the data, the EZY Dose© and Pill Thing© plastics were most compatible with the given solvents.

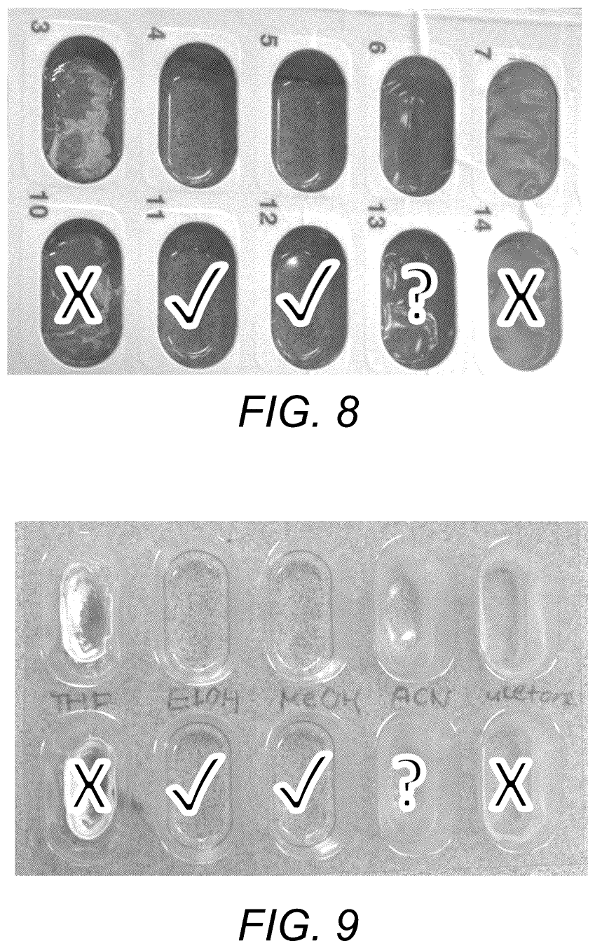

FIG. 8 illustrates samples of different solvents on a Medi-Aid blister pack according to an example embodiment. The Medi-Aid blister pack is shown with solvents, left to right: tetrahydrofuran, ethanol, methanol, acetonitrile, acetone (n=2). FIG. 9 illustrates samples of different solvents on a Pill Thing blister pack according to an example embodiment. The Pill Thing© blister pack is shown with solvents, left to right: tetrahydrofuran, ethanol, methanol, acetonitrile, acetone (n=2). No statistical significance between ethanol and methanol (p>0.05). No statistical significance between acetonitrile and methanol for 2 of the groups (p>0.05). EZY DOSE©-Compatible with MeOH. Pill Thing©-Compatible MeOH and ACN. Medi Aid-Damaged with every solvent. Contact lens cases-Ridges and divots in the plastic could cause deposition challenges.

### Chemical Identification

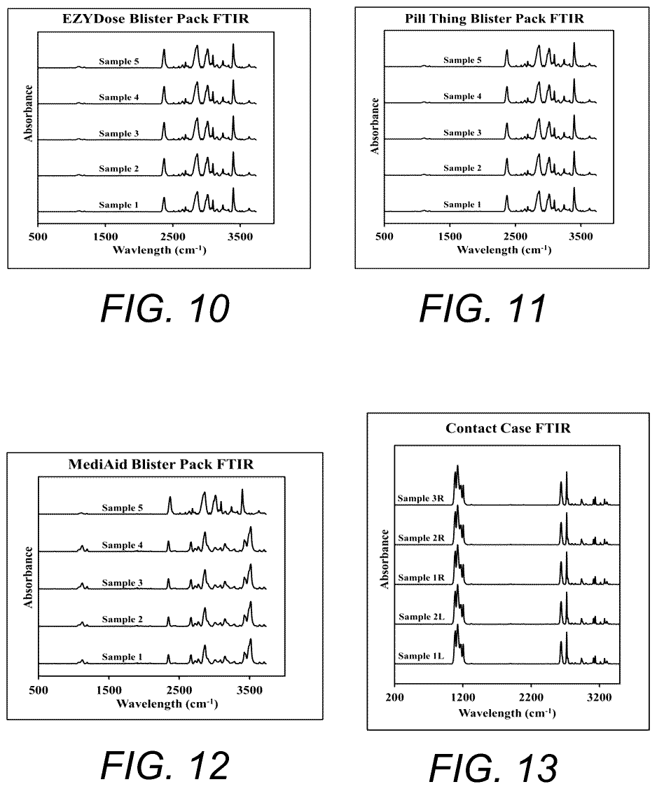

FIG. 10 illustrates FTIR spectrums for an EZY Dose sample. Chemical identity: polyethylene terephthalate glycol (n=5). FIG. 11 illustrates FTIR spectrums for a Pill Thing sample. Chemical identity: polyethylene terephthalate glycol (n=5). FIG. 12 illustrates FTIR spectrums for a Medi-Aid sample. Chemical identity: polyvinyl chloride (n=5). FIG. 13 illustrates FTIR spectrums for a contact lens case sample. Chemical identity: propylene ethylene copolymer (n=5).

The EZY Dose© and Pill Thing© blister packs were chemically identical based off of their respective FTIR spectrums. The spectrums were run through the Know-It-All IR Spectral Database to compare with known samples. The spectrums of the two blister packs are shown in FIGS. 10 and 11. From these spectrums, it was determined that the identity of the plastic was polyethylene terephthalate glycol (PETG). This plastic is less sensitive to chemicals such as methanol and acetonitrile and, thus, could be a plastic used for form development. A similar plastic to PETG is polyethylene terephthalate (PET) which was also considered for form development. These plastics are molecularly the same but built with different glycol monomers.

FIG. 12 shows the spectrums of the Medi-Aid blister pack. From these spectrums, it was determined that the identity of the plastic was polyvinyl chloride (PVC). This aligns with the previous solvent determination because PVC is generally dissolved by strong chemicals like tetrahydrofuran and acetone. FIG. 13 shows the spectrums for the contact lens cases. It was determined that the plastic for these cases was a propylene ethylene copolymer.

### Form Development

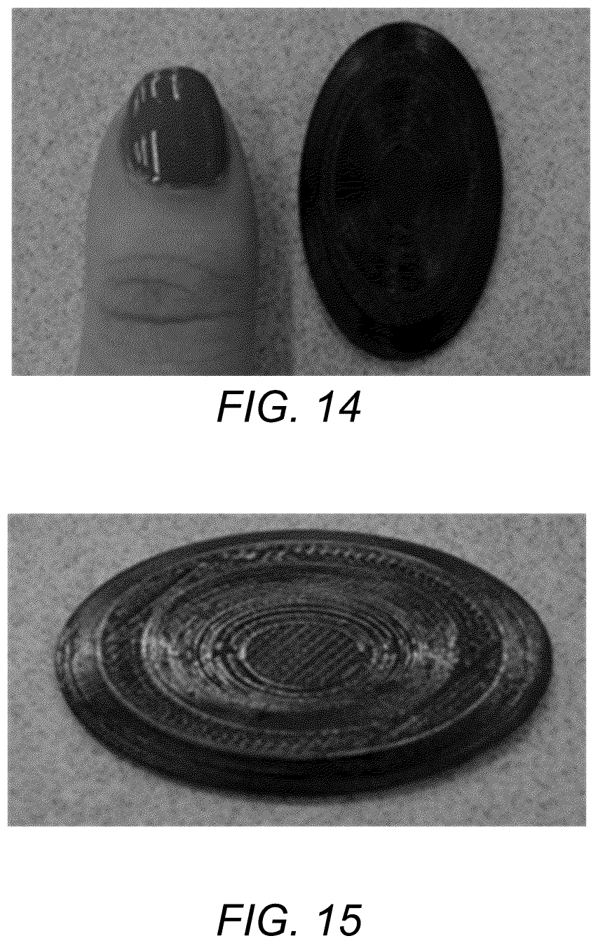

FIG. 14 illustrates a scooped dish form with thumb for size reference according to an example embodiment. The form is prototyped by 3D printing. FIG. 15 illustrates a scooped dish form according to an example embodiment. The form is 3D-printed with black PETG.

### Dimensions: 0.15″×1.0″×1.7″

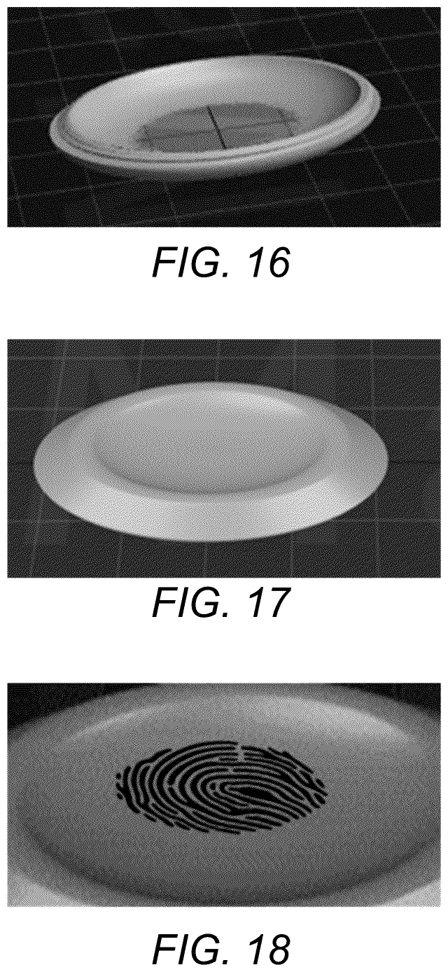

FIG. 16 illustrates a CAD design for a scooped dish form according to an example embodiment. CAD design of an initial dish design in ideaMaker. Dimension: 0.15″×1.0″×1.7″. FIG. 17 illustrates a CAD design for a scooped dish form according to an example embodiment. The FIG. 18 illustrates a CAD design for a scooped dish form with a thumbprint for reference according to an example embodiment. Similar designs are created with similar dimensions, but varying features such as rim size and shallowness of the dish. Sizing is appropriate for an average fingerprint. Forms were developed using 3-dimensional printing. The forms were designed to develop a shallow cavity where the explosive can be deposited and tested in the field. Initial designs used the blister pack concavity as a baseline. A depth of the dish shape can affect the ability to retrieve explosives from the form, e.g., when swabbing into the dish shape.

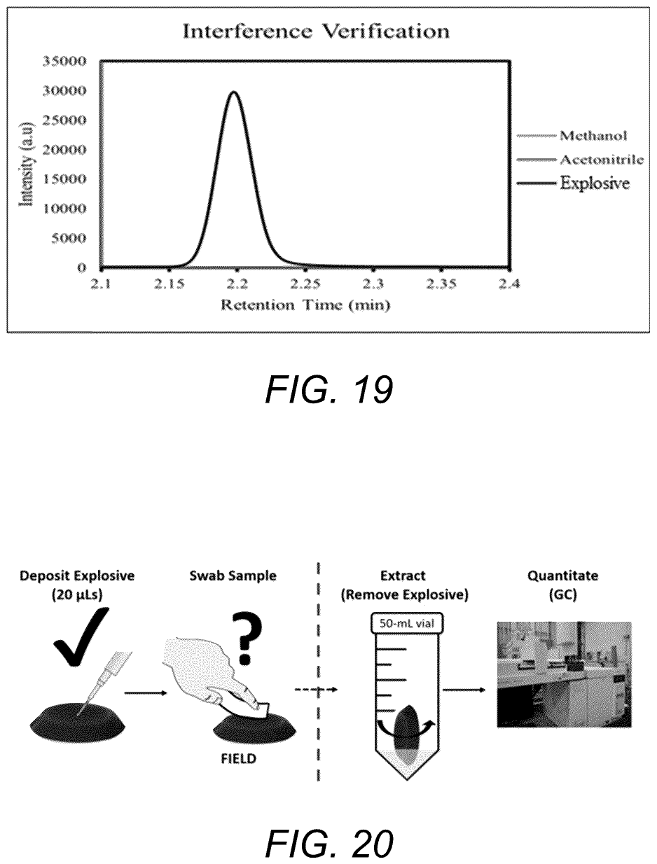

FIG. 19 illustrates a chromatogram to check interference between explosives, a prototype, and solvents according to an example embodiment. Solvent=methanol or acetonitrile. Plastic=Polyethylene Terephthalate Glycol (PETG). Form Chosen: Scooped Dish. After production of the design, one dish was submersed in acetonitrile and another in methanol and run on the gas chromatograph. In addition, a sample of the selected explosive in acetonitrile was run. FIG. 8 is a gas chromatogram that shows the combined chromatograms at 2.2 minutes for the three different samples. From this data, it can be verified that the explosive, acetonitrile, methanol, and the PETG dish do not interfere with one another at the retention time of the explosive.

### Extraction Method

FIG. 20 illustrates a diagram of an example method according to an example embodiment. Initial results indicated that the washing method was not as effective at recovering explosive compared to complete submersion. Below is FIG. 9 which is a comparison of the chromatograms of the wash and submersion methods side-by-side. There is a significant difference between the submersion and wash methods with both 20 μL (n=2, p=0.001) and 100 μL depositions (n=2, p<0.001). The submersion method yielded a larger recovery for the explosive. After initial testing was conducted, it was determined that 20 μL would be preferential to 100 μL deposition. 20 μLs has a faster solvent evaporation rate and thus would be more efficient to use for multiple experiments during a short period of time.

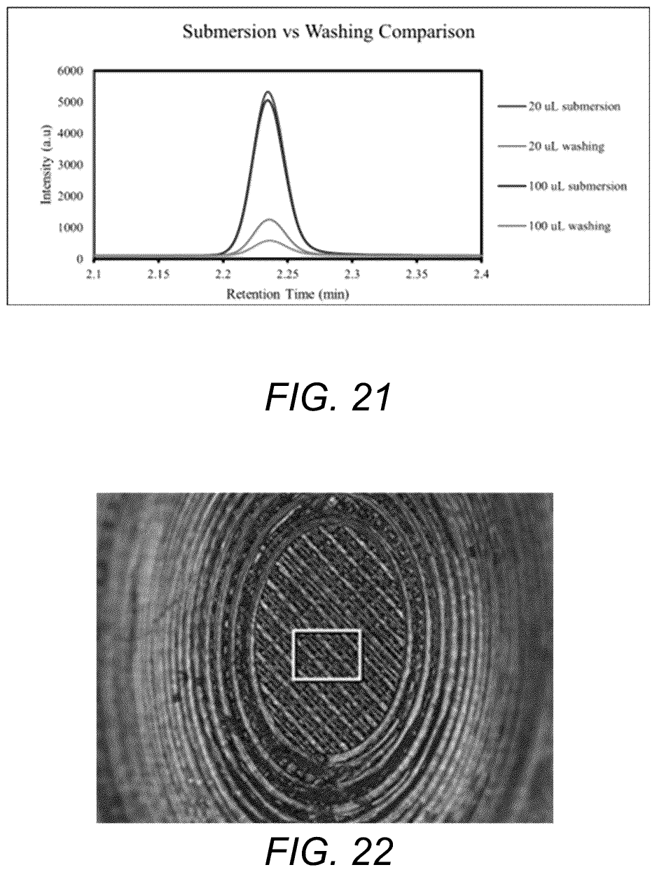

FIG. 21 illustrates a chromatogram to check extraction methods according to an example embodiment. Gas chromatogram, extraction method comparison at the retention time of the explosive (2.20-2.30). Submersion yields higher recovery than washing for both the 20 μL (n=2) and 100 μL (n=2) deposition volumes (p<0.001).

### Verification of Feasibility

FIG. 22 illustrates a microscope optical scan of an example form according to an example embodiment. Microscope optical scan of a 3D-printed dish. Visible striations and layers are boxed. While evaluating the feasibility of using the dishes in the field, several challenges were faced. First, the explosive in methanol could not be quantified. When a calibration curve was run on the gas chromatograph, peak area varied with injections of the same vial. After the possibility of machine errors was eliminated, it was determined that methanol is not an ideal solvent for use with the selected explosive. It is considered only slightly soluble and thus this may cause challenges with quantification. Due to this issue, acetonitrile was the chosen solvent. Samples of the explosive from AccuStandard and Cerilliant come in acetonitrile and previous calibration curves were made using acetonitrile.

After deciding to deposit the explosive in acetonitrile onto the dishes, another challenge arose. No positive color changes were observed with the explosive-deposited dishes. The colorimetric kit was not detecting explosive on the 3D dishes. There were several possible explanations as to why the explosive was not successfully swabbed from the dishes. The most likely explanation had to do with the fact that the dishes were 3-dimensionally printed. These prints had many grooves and a cross-hatched microscope appearance. This form could cause the explosive to be retained in the grooves of the dish and not be retrievable by the swabs. The other possible explanation may be the porosity of PETG when printed. The heating of the material may cause a more porous sample that traps the explosive and acetonitrile within the material. Due to these challenges, other flat-surfaced samples of PETG and PET were used with the colorimetric testing kit. Used a section of PET with a flat surface (n=10).

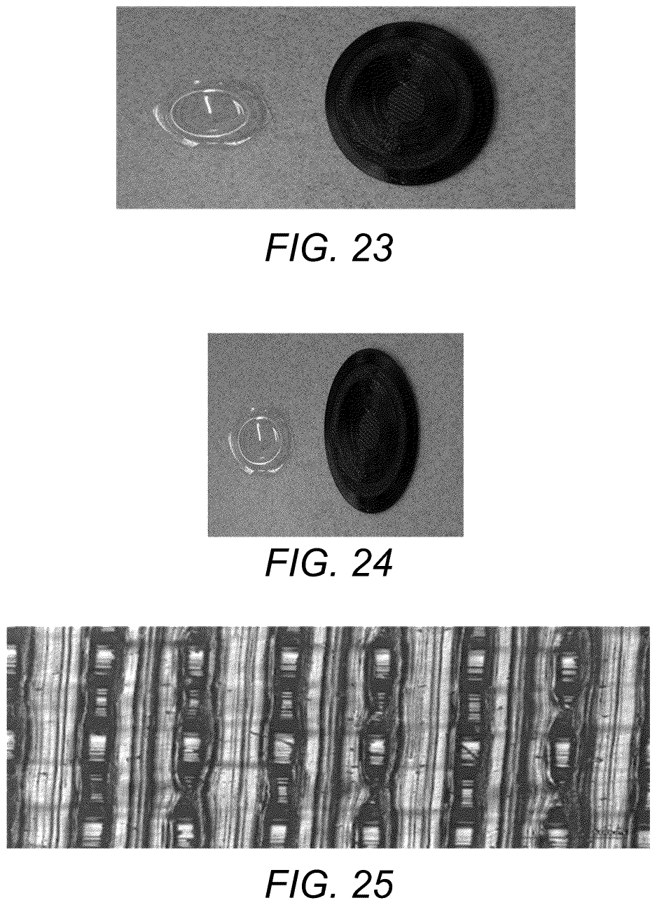

FIG. 23 illustrates a form according to an example embodiment.

FIG. 24 illustrates a form according to an example embodiment.

FIG. 25 illustrates a microscope optical scan of an example form according to an example embodiment. The zoomed in microscope optical image of a 3D-printed dish shows the crosshatched form being visible.

One of the plastic samples chosen was the PETG blister packs from the original solvent testing. These blisters were cut into sheets rather than kept as small pockets. The other samples were cut from the bottom of an egg carton. The egg carton is made of polyethylene terephthalate (PET) which is molecularly identical to PETG. The only difference is in synthesis: they are produced with different glycol monomers. Image 9 is a picture of the bottom of an egg carton with the pieces of interest circled. Image 10 shows the size comparison between this cut-out form and the prototype dish. While the prototype has a good form for swabbing, a plastic continuous sheet was more ideal for further testing.

Table 1 shows the number of positive and negative color changes from each trial. It is evident from the results that it is possible to deposit the explosive on smooth plastic samples and receive a positive color change. If more samples were available, further trials would be conducted to verify these claims.

TABLE 1
Testing PETG and PET-plastic for explosive
samples using a Colorimetric Kit

| | | Number | Number | % success |
|---|---|---|---|---|
| | Number | of positive | of no color | of a positive |
| Trial | of samples | color changes | change | result |
| 3D-printed | 5 | 0 | 5 | 0% |
| dishes | | | | |
| PETG blister | 22 | 20 | 2 | 90.9% |
| packs | | | | |
| PET egg | 10 | 10 | 0 | 100% |
| carton samples | | | | |

### Verification of Feasibility Using PET Plastic

Deposit explosive onto a surface of PET plastic. Invert and drag plastic sample across test stripe. Drop 1 & 2 chemical reagents onto the swab. Record if there is a color change. Sample number=10. Number of Positive results=10.

### Accelerated Shelf-Life Study

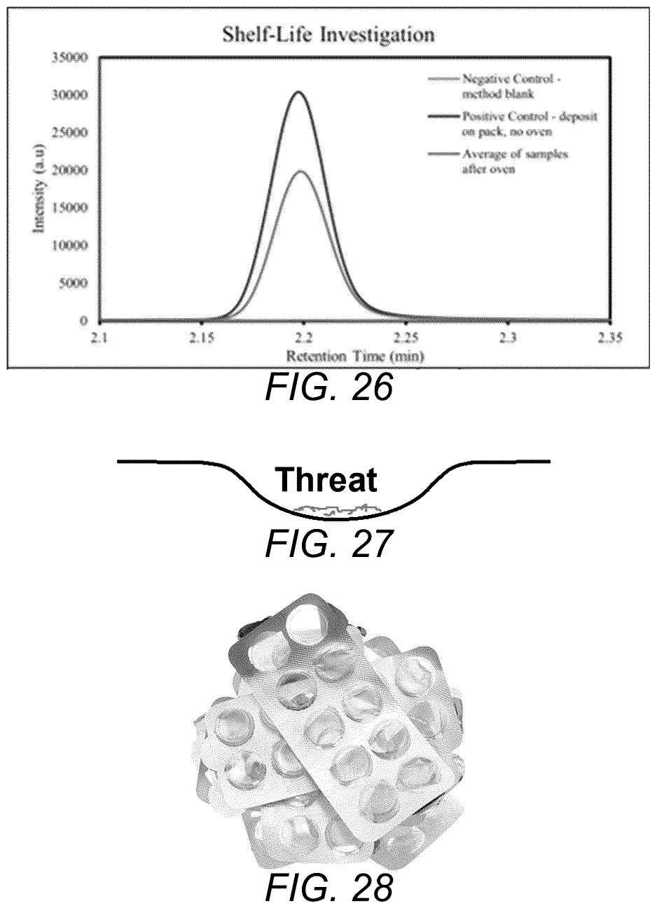

FIG. 26 illustrates a chromatogram comparing recovery of the explosive between controls and samples according to an example embodiment. Gas chromatogram comparing recovery of the explosive between controls and samples placed in an oven for 48 hours during an accelerated shelf-life study.

After determining that it was possible to get a positive color change using smooth plastic containers, a shortened shelf-life study took place. FIG. 10 shows a chromatogram comparing the recovery of the explosive between the controls and samples placed in the oven. Table 3 shows the average percent recovery. This data shows that under the most extreme conditions that these samples may face during transport, there is a 41.3% loss of mass of the explosive. Comparatively, there was a 91.7% recovery of samples just left at room temperature. This loss can be mitigated by establishing storage conditions and protecting samples from extreme temperatures. Sealing the product in the future will be critical. It would be ideal to develop a container that could protect the samples against extreme temperature changes. An extended shelf-life study would also be beneficial to see if long-term storage of the explosive is possible. Overall, while the recovery was not as high as expected, the study verified that it is possible to quantify the samples.

### Potential Reasons for Low Recovery:

Transferred between labs in tray covered in foil
   Outdoor exposure-windy
   Samples were uncovered in oven

### Mitigate Future Potential Loss:

Establish storage conditions
Seal samples in packaging

### Follow-Up 72-Hour Study:

Samples were left in open lab for 72 hours (n=10)
91.7% recovery

TABLE 2
Percent Recovery of the Explosive for Each Sample Group

| | Avg | Avg | Percent |
|---|---|---|---|
| | percent | percent | standard |
| Trial | mass loss | recovery | deviation |
| Positive controls (n = 1) | 4.7% | 95.3% | — |
| Oven samples (n = 22) | 41.3% | 58.7% | 7.1% |
| 72-hour study (n = 10) | 8.3% | 91.7% | 5.7% |

FIG. 27 illustrates a cross-section view of a form containing a threat according to an example embodiment. Compound=Contraband Substance. Solvent=Acetonitrile. Plastic=Polyethylene Terephthalate Glycol. Prototype=Scooped Dish (0.15×1.0×1.7). Form=blister pack form with round indent.

FIG. 28 illustrates forms for containing threats according to an example embodiment. A small and compact prototype was developed as a training aid for colorimetric testing kits. In an embodiment, the solvent was acetonitrile and selected plastic was polyethylene terephthalate glycol (PETG). The selected extraction method was the submersion of the prototype in 3 mL of extracting solvent. Depositions were made on the samples using a deposition volume of 20 μLs of an explosive in solution. A swab test using a colorimetric testing kit verified the feasibility of this embodiment.

The developed embodiments can be used as positive explosive controls for field training. Embodiments can serve as the foundation for future colorimetric testing kit training aids.

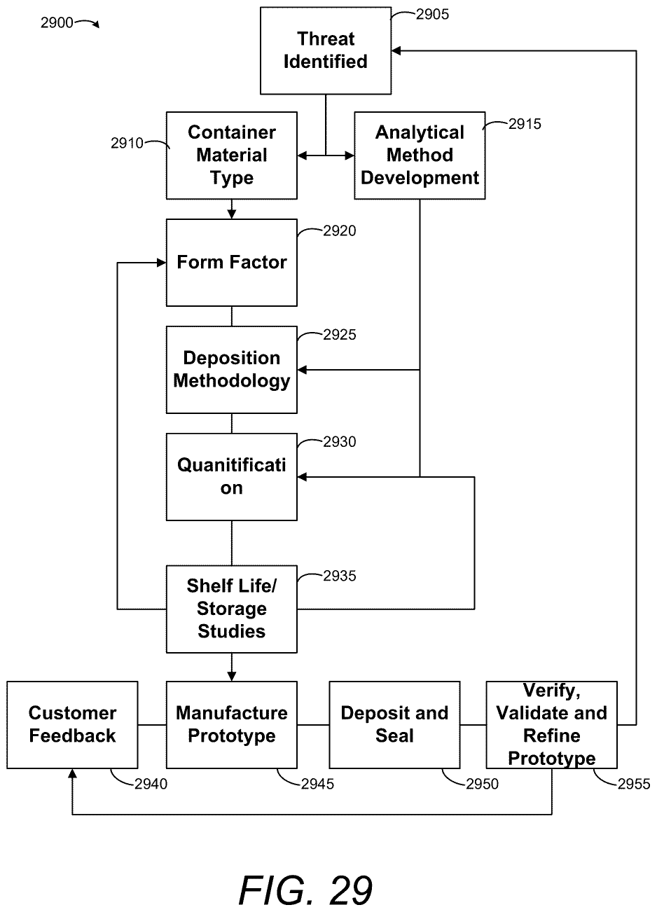

FIG. 29 illustrates a flowchart of a method to refine a prototype form for storing explosives according to an embodiment. At 2905, a threat is identified. At 2910, container material type is selected. At 2915, analytical method is developed. At 2920, form factor is selected. At 2925, deposition methodology is selected. At 2930, testing results are quantified. At 2935, shelf life and storage studies are conducted. At 2940, customer feedback is evaluated. At 2945, a prototype is manufactured. At 2950, deposits are made into the prototype and the prototype is sealed. At 2955, the prototype is verified, validated, and refined.

While a number of example embodiments of the present subject matter have been described, it should be appreciated that the present subject matter provides many applicable inventive concepts that can be embodied in a wide variety of ways. The example embodiments discussed herein are merely illustrative of ways to make and use the subject matter and are not intended to limit the scope of the claimed subject matter. Rather, as will be appreciated by one of skill in the art, the teachings and disclosures herein can be combined or rearranged with other portions of this disclosure and the knowledge of one of ordinary skill in the art.

Terms and phrases used in this document, unless otherwise expressly stated, should be construed as open ended as opposed to closed—e.g., the term “including” should be read as meaning “including, without limitation” or the like; the term “example” is used to provide example instances of the item in discussion, not an exhaustive or limiting list thereof; the terms “a” or should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Furthermore, the presence of broadening words and phrases such as “one or more,” “at least,” “but not limited to,” or other similar phrases, should not be read to mean that the narrower case is intended or required in instances where such broadening phrases may be absent. Any headers used are for convenience and should not be taken as limiting or restricting. Additionally, where this document refers to technologies that would be apparent or known to one of ordinary skill in the art, such technologies encompass those apparent or known to the skilled artisan now or at any time in the future.

1. (canceled)

2. A testing kit to validate detectors, comprising:
a plurality of devices, wherein a given device includes:
packaging comprising a scooped dish shape;
a sealable lid; and
a threat material stored in the packaging at a mass range of nanograms to milligrams;
wherein the plurality of devices include a plurality of different threat materials, stored separately in their own respective scooped dish shape provided by the respective devices, representing at least those types of threat materials that the detectors detect.

3. A method to prepare a testing kit to validate detectors, comprising:
dissolving a threat material in a solvent to form a solution;
disposing the solution in a packaging having a scooped dish shape; and
sealing the packaging with a sealable lid.

4. The testing kit of claim 2, wherein the packaging comprises at least one of PVC, PVC laminates such as PVC-coated with PTFE, aluminum, aluminum laminates, polyethylene terephthalate (PET) or polyethylene terephthalate glycol (PETG).

5. The testing kit of claim 2, wherein the sealable lid is aluminum.

6. The testing kit of claim 2, wherein the testing kit is a colorimetric testing kit, and the threat material stored in the packaging is for performing colorimetric testing to validate the detectors.

7. The testing kit of claim 2, wherein the threat material stored in the packaging is for performing trace swabbing to validate the detectors.

8. The testing kit of claim 2, wherein the packaging is sized as approximately 48 mm long, 31 mm wide, and 10 mm high.

9. The testing kit of claim 2, wherein the plurality of devices include a plurality of different scooped dish shapes to accommodate different vendor-specific swabs used to swab the threat material from the packaging.

10. The testing kit of claim 2, wherein the threat material is a liquid solution including a threat dissolved in a solvent.

11. The testing kit of claim 10, wherein the solvent is at least one of methanol, acetonitrile, ethanol, acetonitrile, toluene, acetone, or tetrahydrofuran.

12. The testing kit of claim 2, wherein the packaging is capable of elastic deflection that allows for inverting the packaging to deposit the threat material onto a testing surface or swab.

13. The testing kit of claim 2, wherein the packaging is transparent plastic, allowing for testing the threat material directly in the packaging without needing to remove the threat material from the packaging.

14. The testing kit of claim 2, wherein a given device of the plurality of devices further includes an absorbent layer in a threat receptacle area of the given device, to facilitate retention of the threat material that is liquid.

15. The testing kit of claim 2, further comprising a perforated layer disposed between a threat receptacle of the packaging and the sealable lid, the perforated layer enabling vapor to permeate out in a controlled manner facilitating use in vapor testing scenarios.

16. The testing kit of claim 2, wherein the scooped dish shape is sized to accommodate a fingerprinting acquisition area of 0.5″×0.7″.

17. The testing kit of claim 2, wherein the scooped dish shape includes a raised rim.

18. The testing kit of claim 2, wherein the threat material is a narcotic.

19. The testing kit of claim 2, wherein the threat material is a quantity of Fentanyl dissolved in acetonitrile ranging in concentration in a range of ng/uL.

20. The testing kit of claim 2, wherein the threat material is a gas forming reagent (GFR).

21. The testing kit of claim 2, wherein the threat material is Research Department explosive (RDX) explosive compound.

22. The testing kit of claim 2, wherein the threat material is trinitrotoluene (TNT) explosive compound.

23. The method of claim 3, further comprising heat/cold sealing the sealable lid to the packaging.

24. The method of claim 3, further comprising, prior to sealing the packaging, evaporating the solvent from the solution.

25. The method of claim 3, further comprising:
removing the sealable lid to unseal the packaging;
elastically deflecting the packaging to invert the scooped dish shape of the packaging to access to the threat material; and
depositing the threat material onto a testing surface or swab.

26. The method of claim 3, further comprising vacuum sealing the packaging with the sealable lid.

27. The method of claim 3, further comprising:
removing the sealable lid to unseal the packaging and expose a perforated layer disposed under the sealable lid above a threat receptacle of the packaging; and
allowing vapor to permeate out in a controlled manner through the perforated layer to facilitate use in vapor testing scenarios.
